(19) United States
(12) Patent Application Publication
(10) Pub. No.: US 2025/0386296 A1
(43) Pub. Date: Dec. 18, 2025

(54) METHOD, DEVICE AND COMPUTER STORAGE MEDIUM OF COMMUNICATION

(71) Applicant: NEC Corporation, Tokyo (JP)

(72) Inventors: Zonghui XIE, Beijing (CN); Gang WANG, Beijing (CN)

(73) Assignee: NEC Corporation, Tokyo (JP)

(21) Appl. No.: 18/877,453

(22) PCT Filed: Jul. 1, 2022
(86) PCT No.: PCT/CN2022/103440

§ 371 Date: Dec. 20, 2024

(51) Int. Cl. H04W 52/02

(52) U.S. Cl. CPC H04W 52/0235; H04W 52/0206

(57) ABSTRACT

Embodiments of the present disclosure relate to methods, devices and computer readable media of communication. A terminal device receives a configuration for wake up of a first cell, and transmits a wake up request to the first cell based on the configuration. The configuration comprises at least one of the following: a first configuration for transmission of the wake up request; or a second configuration for detection of a change of an operation mode of the first cell from a first mode to a second mode, the first mode having deeper energy saving than the second mode. In this way, a network may be activated from a deeper energy saving mode to a lighter energy saving mode.

### FIELD

Embodiments of the present disclosure generally relate to the field of telecommunication, and in particular, to methods, devices and computer storage media of communication for network energy saving situation.

### BACKGROUND

Recently, network energy saving situation is highly concerned. It has been proposed to increase time domain energy saving opportunities by a network for energy saving. It also has been proposed to study a mechanism to utilize potential energy saving states or sleep modes and transition between states from leveraging cell on/off opportunities. However, many aspects of such mechanism are still incomplete and needs to be further developed.

### SUMMARY

In general, embodiments of the present disclosure provide methods, devices and computer storage media of communication for network energy saving situation.

In a first aspect, there is provided a method of communication. The method comprises: receiving, at a terminal device, a configuration for wake up of a first cell; and transmitting a wake up request to the first cell based on the configuration, the configuration comprising at least one of the following: a first configuration for transmission of the wake up request; or a second configuration for detection of a change of an operation mode of the first cell from a first mode to a second mode, the first mode having deeper energy saving than the second mode.

In a second aspect, there is provided a method of communication. The method comprises: transmitting, at a network device, a configuration for wake up of a first cell, the configuration comprising at least one of the following: a first configuration for transmission of a wake up request; or a second configuration for detection of a change of an operation mode of the first cell from a first mode to a second mode, the first mode having deeper energy saving than the second mode.

In a third aspect, there is provided a device of communication. The device comprises a processor configured to perform the method according to the first or second aspect of the present disclosure.

In a fourth aspect, there is provided a computer readable medium having instructions stored thereon. The instructions, when executed on at least one processor, cause the at least one processor to perform the method according to the first or second aspect of the present disclosure.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication according to embodiments of the present disclosure;

FIG. 3 illustrates a schematic diagram illustrating an example configuration of a time window according to embodiments of the present disclosure;

FIG. 4A illustrates a schematic diagram illustrating an example mapping between occasions for wake up request transmission and synchronization signal and physical broadcast channel blocks (SSBs) according to embodiments of the present disclosure;

FIG. 4B illustrates a schematic diagram illustrating another example mapping between occasions for wake up request transmission and SSBs according to embodiments of the present disclosure;

FIG. 4C illustrates a schematic diagram illustrating another example mapping between occasions for wake up request transmission and SSBs according to embodiments of the present disclosure;

FIG. 5A illustrates a schematic diagram illustrating an example detection for wake up of a cell according to embodiments of the present disclosure;

FIG. 5B illustrates a schematic diagram illustrating an example scenario in detection for wake up of a cell according to embodiments of the present disclosure;

FIG. 5C illustrates a schematic diagram illustrating another example detection for wake up of a cell according to embodiments of the present disclosure;

FIG. 6A illustrates a schematic diagram illustrating an example scenario of mode change of a cell according to embodiments of the present disclosure;

FIG. 6B illustrates a schematic diagram illustrating another example scenario of mode change of a cell according to embodiments of the present disclosure;

FIG. 7A illustrates a schematic diagram illustrating an example determination of a boundary of a switch period according to embodiments of the present disclosure;

FIG. 7B illustrates a schematic diagram illustrating another example determination of a boundary of a switch period according to embodiments of the present disclosure;

FIG. 7C illustrates a schematic diagram illustrating another example determination of a boundary of a switch period according to embodiments of the present disclosure;

FIG. 7D illustrates a schematic diagram illustrating another example determination of a boundary of a switch period according to embodiments of the present disclosure;

FIG. 8 illustrates an example method of communication implemented at a terminal device in accordance with some embodiments of the present disclosure;

FIG. 9 illustrates an example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS). extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “core network (CN) device” refers to any device or entity that provides access and mobility management function, session management function (SMF), user plane function (UPF), etc. By way of example rather than limitation, the CN device may be a mobility management entity (MME), an AMF, a SMF, a UPF, etc. In other embodiments, the CN device may be any other suitable device or entity.

As used herein, the term “access network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Currently, some techniques and enhancements are proposed for network energy saving in the following aspects: increasing time domain energy saving opportunities; frequency resource usage adaptation; adaptation of number of spatial elements; and adaptation of transmission or reception processing of signals or channels. As to techniques and enhancements for increasing time domain energy saving opportunities by gNB, it is needed to further study a mechanism to utilize potential energy saving states or sleep modes and the transition between states from leveraging cell on/off opportunities.

Embodiments of the present disclosure provide a solution of communication for waking up a cell so as to solve potential problems of utilizing potential energy saving states or sleep modes and transition between modes or states. In this solution, a terminal device receives a configuration for wake up of a cell (for convenience, also referred to as a first cell or a target cell herein). Based on the configuration, the terminal device transmits a wake up request to the cell. The configuration comprises at least one of the following: a first configuration for transmission of the wake up request; or a second configuration for detection of a change of an operation mode of the cell from a first mode to a second mode, the first mode having deeper energy saving than the second mode.

In this way, a terminal device may activate a network from a deeper energy saving mode to a lighter energy saving mode.

Principle and example embodiments of the present disclosure will be described in detail below with reference to the accompanying drawings.

### Example of Communication Network

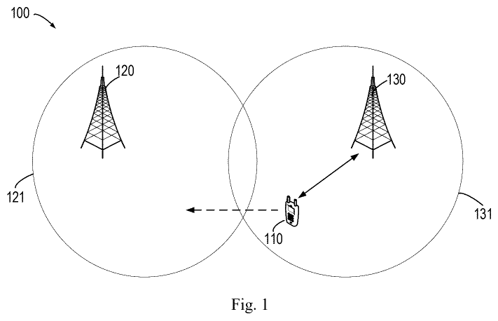

FIG. 1 illustrates a schematic diagram of an example communication network 100 in which some embodiments of the present disclosure can be implemented. As shown in FIG. 1, the communication network 100 may include a terminal device 110 and network devices 120 and 130. The network device 120 provides a cell 121 and the network device 130 provides a cell 131 for serving one or more terminal devices. The terminal device 110 may be served by any of the network devices 120 and 130.

It is to be understood that the number of devices or cells in FIG. 1 is given for the purpose of illustration without suggesting any limitations to the present disclosure. The communication network 100 may include any suitable number of network devices and/or terminal devices adapted for implementing implementations of the present disclosure. Further, each of the network devices 120 and 130 may provide more cells.

As shown in FIG. 1, the terminal device 110 may communicate with the network device 120 or 130 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the network devices 120 and 130 may be different network devices. In some embodiments, the network devices 120 and 130 may be the same network device.

In some scenarios, the network device 120 may be in a low load state where a small number of terminal devices (not shown) or no terminal devices are in the cell 121 and connecting to the network device 120. In this case, the network device 120 may switch to an energy saving mode. As neighboring load increases, or the terminal device 110 entering the cell 121, the terminal device 110 needs to activate the cell 121 of the network device 120 from the current energy saving mode to a lighter energy saving mode (e.g., a normal operation mode).

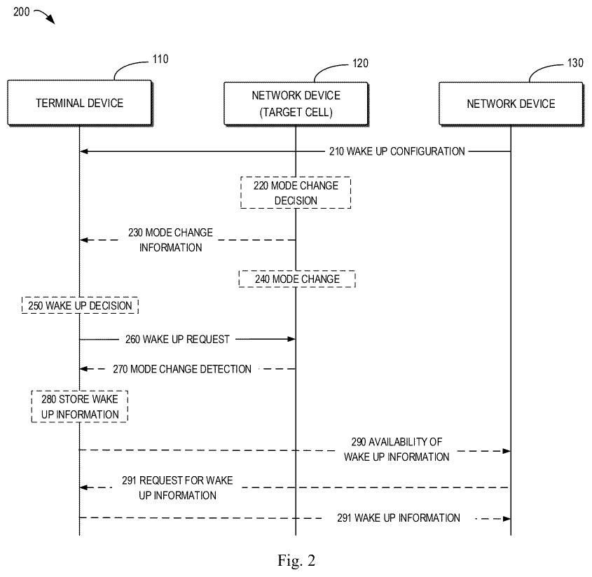

Embodiments of the present disclosure provide a solution of activating a cell from a deeper energy saving mode to a lighter energy saving mode. More details will be described below in connection with FIGS. 2 to 6F.

In the context of the present disclosure, an energy saving mode of a network (NW) may comprise but not be limited to any of the following:
Normal: NW operates in a legacy way and no network energy saving technic is used, UE can camp and access normally;
Micro sleep: NW turns off a transmitter/receiver (TRX) and power amplification (PA) for short inactivity gaps;
Light sleep: Some PA, TRX and related analog processing units in intelligent resilient frame work (IRF) are turned off, which implements the function of turning off some TRXs, such as 64 TRX turns off to 32 TRX;
Deep sleep: Most of the PA, TRX, and IRF units are turned off, leaving a minimum set of units in operation;
Ultra-deep sleep: active antenna unit (AAU) turns off almost all the hardware units;
Power-off: UE cannot even discover the NW, and consider the NW does not exist.

It can be seen that energy saving mode classification from normal to power-off has more hardware, PA, TRX IRF units turn off; longer inactivity gaps; longer SSB period, DRX/eDRX period, etc. Alternatively, energy saving mode classification may also be described as TX-only/RX-only, switch on/switch off or activation/deactivation of cells. Or no explicit mode classifications but only some key performance indicators (KPIs) are used.

### Example Implementation of Activation of Cell

FIG. 2 illustrates a schematic diagram illustrating a process 200 of communication according to embodiments of the present disclosure. For the purpose of discussion, the process 200 will be described with reference to FIG. 1. The process 200 may involve the terminal device 110 and the network devices 120 and 130 as illustrated in FIG. 1. It is assumed that the network device 120 and the network device 130 are in a normal mode, and the network device 120 provides a target cell (i.e., a first cell) to be woken up.

### 1. Wake Up Configuration

As shown in FIG. 2, the network device 130 may transmit 210, to the terminal device 110, a configuration for wake up of a first cell.

In some embodiments, the configuration may comprise a configuration (for convenience, also referred to as a first configuration or a request transmission configuration herein) for transmission of a wake up request. In some embodiments, the configuration may comprise a configuration (for convenience, also referred to as a second configuration or a detection configuration herein) for detection of a change of an operation mode of the first cell from a first mode to a second mode, the first mode having deeper energy saving than the second mode. It is to be understood that the configuration may comprise any combination of the first configuration, the second configuration and any other suitable configuration.

### 1) Request Transmission Configuration

### Transmission Time Window

In some embodiments, the first configuration (i.e., request transmission configuration) may comprise information of a time window for transmission of a wake up request. In some embodiments, the information of the time window may comprise information for determining a starting position of the time window and a duration of the time window.

In some embodiments, the information for determining the starting position of the time window may comprise periodicity of the time window, an offset of a system frame of the time window, and a starting subframe of the time window. For example, a system frame of the time window may be determined based on equation (1) below,

$$SFN mod period = offset \qquad ( 1 )$$

where SFN denotes a system frame number of the time window, period denotes periodicity of the time window, and offset denotes an offset of a system frame of the time window. The time window occurs at an SFN meeting the condition described in the equation (1), and then the starting position of the time window may be determined based on the starting subframe of the time window.

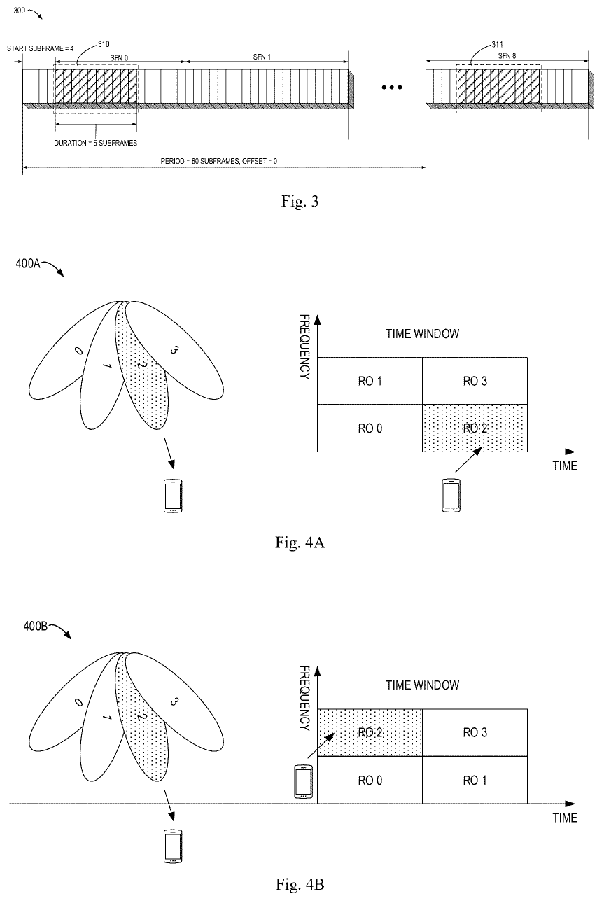

FIG. 3 illustrates a schematic diagram 300 illustrating an example configuration of a time window according to embodiments of the present disclosure. In this example, it is assumed that subcarrier spacing (SCS)=30 kHz and 1 subframe=2 slot. It is also assumed that period=80 subframes, offset=0, starting subframe=4, and duration=5 subframes. It can be known from equation (1) that SFN=0, 8 based on period=80 subframes and offset=0. Then time windows 310, 311 can be determined based on starting subframe=4, and duration=5 subframes. It is to be understood that FIG. 3 is merely an example, and does not limit the present disclosure. Any other suitable time units are also feasible.

In some alternative embodiments, the information for determining the starting position of the time window may comprise an offset to an SSB transmission. In some embodiments, the offset to an SSB transmission may comprise a time offset to time domain positions of SSBs. For example, the time offset to time domain positions of SSBs may be a time offset to time domain positions of candidate SSBs (i.e., the first symbol of SSB index=0). In some embodiments, the offset to an SSB transmission may comprise a time offset to a half frame with SSBs. In some embodiments, the offset to an SSB transmission may comprise a time offset to a subframe or slot in which an SSB starts.

In some alternative embodiments, the information for determining the starting position of the time window may comprise an offset to an SSB measurement timing configuration (SMTC) window. For example, the offset to a SMTC window may comprise a time offset to the first or last subframe of each SMTC occasion.

In some alternative embodiments, the information for determining the starting position of the time window may comprise an offset to a predefined signal. For example, the offset to a predefined signal may be a time offset to time domain positions of the predefined signal. For example, the predefined signal may be a signal for discovery or measurements for dormant state. Any other suitable signals are also feasible.

In some alternative embodiments, the information for determining the starting position of the time window may comprise an offset to a paging occasion (PO)/paging transmission window (PTW). For example, the offset to a PO/PTW may be a time offset to the first or last subframe of each PO/PTW.

In some alternative embodiments, the starting position of the time window may determined by reusing physical random access channel (PRACH) resources. In some alternative embodiments, the terminal device 110 may transmit a wake up request at any time, and detection of a wake up request may be always on.

It is to be understood that the information for determining the starting position of the time window may comprise any combination of the above information and/or any other suitable information.

### Occasions in Time Window

In some embodiments, a time window (for example, the time window 310 or 311) may comprise occasions (for convenience, also referred to as request occasions (ROs) herein) associated with SSBs. In some embodiments, there may be a mapping between SSBs or other DL RSs or discovery signals and occasions for wake up request transmission.

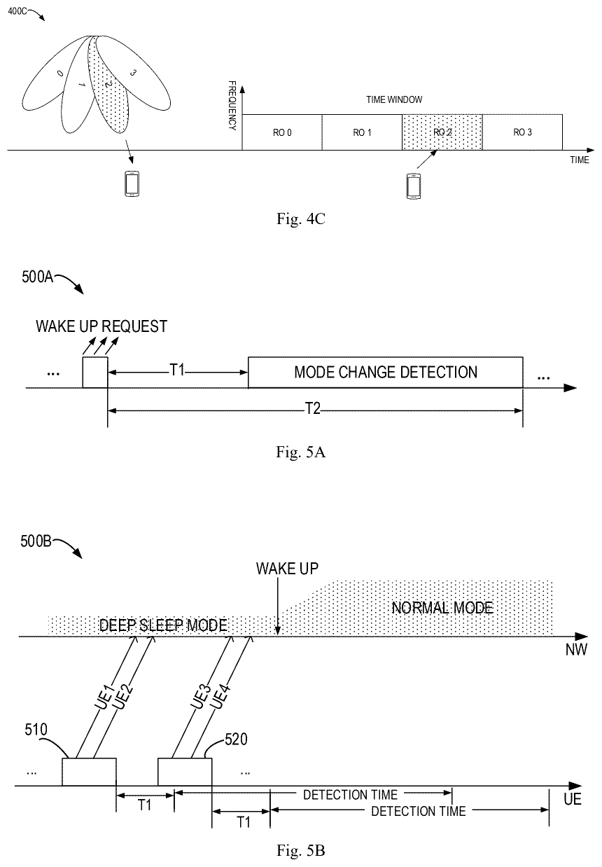

In some embodiments, the mapping may be designed first according to increasing indexes of ROs of frequency division multiplexing (FDM) and then according to increasing indexes of ROs of time division multiplexing (TDM). FIG. 4A illustrates a schematic diagram 400A illustrating an example mapping between occasions for wake up request transmission and SSBs according to embodiments of the present disclosure. It is assumed that an SSB over a beam 0 is mapped to RO 0, an SSB over a beam 1 is mapped to RO 1, an SSB over a beam 2 is mapped to RO 2, and an SSB over a beam 3 is mapped to RO 3. In the example of FIG. 4A, indexes of ROs are increased first in a frequency domain and then in a time domain.

In some embodiments, the mapping may be designed first according to increasing indexes of ROs of TDM and then according to increasing indexes of ROs of FDM. FIG. 4B illustrates a schematic diagram 400B illustrating another example mapping between occasions for wake up request transmission and SSBs according to embodiments of the present disclosure. It is assumed that an SSB over a beam 0 is mapped to RO 0, an SSB over a beam 1 is mapped to RO 1, an SSB over a beam 2 is mapped to RO 2, and an SSB over a beam 3 is mapped to RO 3. In the example of FIG. 4B, indexes of ROs are increased first in a time domain and then in a frequency domain.

In some embodiments, the mapping may be designed only according to increasing indexes of ROs of TDM. FIG. 4C illustrates a schematic diagram 400C illustrating another example mapping between occasions for wake up request transmission and SSBs according to embodiments of the present disclosure. It is assumed that an SSB over a beam 0 is mapped to RO 0, an SSB over a beam 1 is mapped to RO 1, an SSB over a beam 2 is mapped to RO 2, and an SSB over a beam 3 is mapped to RO 3. In the example of FIG. 4C, indexes of ROs are increased only in a time domain. In some embodiments, the mapping may be designed only according to increasing indexes of ROs of FDM.

In some embodiments, which of the above mapping embodiments is used can also be configured by a network. It is to be understood that the mapping may also adopt any other suitable ways.

### Transmission Condition

In some embodiments, the first configuration may comprise a condition for transmission of a wake up request.

In some embodiments, the condition for transmission of a wake up request may comprise an indication to transmit a wake up request being received from another cell (for convenience, also referred to as a third cell herein). In other words, if the terminal device 110 receives the indication from another cell (e.g., when traffic load is high), the terminal device 110 may determine to transmit a wake up request to the first cell.

In some embodiments, the condition for transmission of a wake up request may comprise quality of another cell (for convenience, also referred to as a fourth cell herein) being below threshold quality. In some embodiments, cell quality may be obtained from measurements of DL RS. In some embodiments, cell quality may be represented by at least one of the following parameters: reference signal receiving power (RSRP), reference signal receiving quality (RSRQ), received signal strength indicator (RSSI), signal to interference plus noise ratio (SINR) or signal to noise ratio (SNR).

In some embodiments, a RRC_CONNECTED UE may inform a network B upon decision of waking up a network A. In some embodiments, up to implementation, a RRC_CONNECTED UE may transmit a wake up request during an inactive period or an off duration. In some embodiments, handover and cell re-selection may have a higher priority than that of wake up requesting.

In some embodiments, the condition for transmission of a wake up request may comprise no cell to camp on. In some embodiments, if there is no suitable cell to camp on hence the terminal device 110 is in any cell search state, the terminal device 110 may decide to transmit the wake up request.

It is to be understood that the condition for transmission of a wake up request may comprise any combination of the above conditions and/or any other suitable conditions.

### Other Configurations

In some embodiments, the first configuration may comprise a maximum number of wake up request attempts. In some embodiments, the maximum number of wake up request attempts may comprise maximum times of wake up request attempts. For example, the terminal device 110 does not expect to transmit a wake up request after Q unsuccessful attempts, where Q is a positive integer. In some embodiments, the maximum number of wake up request attempts may comprise maximum times of wake up request attempts in a period of time (e.g., in a time window 310 or 311). For example, the terminal device 110 may only try to wake up the first cell for P times within a period of time T, where P is a positive integer and T is a time length such as 60 min, 24 hours or the like. It is to be understood that the maximum number of wake up request attempts may comprise any combination of the above information and/or any other suitable information.

In some embodiments, the first configuration may comprise maximum number of repetitions for a wake up request attempt. In some embodiments, the maximum number of repetitions may be determined according to serving quality.

In some embodiments, the first configuration may comprise earliest time of transmission of the wake up request. In some embodiments, the terminal device 110 may be allowed to transmit a wake up request after the earliest time. In some embodiments, the terminal device 110 may be allowed to transmit a wake up request only during a time period, for example, during the time window after the earliest time.

In some embodiments, the first configuration may comprise an indication of synchronization between network A and network B. For example, if network A is indicated as synchronized with network B, DL synchronization with SSBs or other RS signals before transmission of a wake up request is not needed.

In some embodiments, the first configuration may comprise an indication indicating whether a system frame number (SFN) and a frame boundary are aligned between a serving cell and a neighboring cell. For example, if the SFN and frame boundary are not aligned, it is necessary to indicate to refer to the serving cell or neighboring cell. Alternatively, use of this feature should guarantee that the SFN and frame boundary across serving cell and neighbour cells are aligned.

It is to be understood that the first configuration may comprise any combination of the above configurations and/or any other suitable configurations. In this way, a time domain resource is specified for a terminal device to activate a cell.

### 2) Detection Configuration

### Earliest Time

A network may need time to evaluate whether to wake up. The network may also need ramp up time. In some embodiments, the second configuration (i.e., detection configuration) may comprise earliest time (denoted as T1) for detecting the change of the operation mode of the first cell.

In some embodiments, after T1 elapses upon transmission of a wake up request, the terminal device 110 may detect the change of the operation mode of the first cell. In other words, T1 may start upon transmission of a wake up request.

In some embodiments, after T1 elapses from the end of a time window during which a wake up request is transmitted, the terminal device 110 may start to detect the change of the operation mode of the first cell. In other words, T1 may start at the end of a time window during which a wake up request is transmitted.

In some embodiments, T1 may be determined by the number of time windows. For example, the start of the N^{th} time window after transmission of a wake up request may be determined as T1.

### Latest Time

A network may decide not to wake up due to only a few wake up requests received or received power lower than threshold power. In some embodiments, the second configuration may comprise latest time (denoted as T2) for detecting the change of the operation mode of the first cell. If a network is not woken up after T2, the terminal device 110 considers that the transmitted wake up request is unsuccessful or being rejected.

In some embodiments, T2 may start upon transmission of a wake up request. In some embodiments, T2 may start at the end of a time window during which a wake up request is transmitted. In some embodiments, T2 may start at expiration of T1. FIG. 5A illustrates a schematic diagram 500A illustrating an example detection for wake up of a cell according to embodiments of the present disclosure. In the example of FIG. 5A, both T1 and T2 start at the end of a time window during which a wake up request is transmitted.

In some embodiments where a network is not woken up, after T2, the terminal device 110 may still search for this network. This network may probably wake up later by other terminal devices. In some embodiments, after T2, the terminal device 110 may initiate another wake up request attempt.

In this case, terminal devices which transmit wake up requests on different time or during different time windows may detect a change of an operation mode of a cell on different time or during different time periods. FIG. 5B illustrates a schematic diagram 500B illustrating an example scenario in detection for wake up of a cell according to embodiments of the present disclosure.

As shown in FIG. 5B, UE1 and UE2 transmit wake up requests in the time window 510, and detect wake up of a network (NW) after T1 elapses at the end of the time window 510. UE3 and UE4 transmit wake up requests in the time window 520, and detect wake up of a NW after T1 elapses at the end of the time window 520. In this example, UE1 to UE4 may detect a change of a NW from a deep sleep mode to a normal mode.

### Switch Period

In some embodiments, the whole time may be divided into periods (also referred to switch periods herein) alternatively used for wake up request transmission and mode change detection. In this case, mode change detection may be made in a switch period following a switch period in which a wake up request is transmitted.

In some embodiments, the second configuration (i.e., detection configuration) may comprise information for determining switch periods. For example, the second configuration may comprise the number of system frames for determining switch periods. In some embodiments, a length of a switch period is equal to predefined number of system frames. It is to be understood that any other suitable information for determining switch periods is also feasible.

FIG. 5C illustrates a schematic diagram 500C illustrating another example detection for wake up of a cell according to embodiments of the present disclosure. As shown in FIG. 5C, there may be a plurality of switch periods alternatively used for wake up request transmission and mode change detection. A boundary may be defined between two switch periods. The terminal device 110 may try to detect a NW from the boundary after transmitting a wake up request. The detecting time may start from the boundary and may last for period of time T. In some embodiments, T may equal to a predetermined number of switch periods. The predetermined number may be any suitable positive integers. After T elapses, the terminal device 110 may still search for the NW if the NW is not woken up. The NW may be probably woken up later by other terminal devices. Alternatively, the terminal device 110 may initiate another wake up request attempt after T elapses.

It is to be understood that the second configuration may comprise any combination of the above configurations and/or any other suitable configurations. In this way, a terminal device only needs to detect a change of an operation mode of a cell during a certain period of time after transmission of a wake up request. Thus, immediate detection or always detection may be avoided.

### 2. Transmission of Wake Up Request

### Mode Change Information

Continue to refer to FIG. 2, the network device 120 (e.g., the cell 121) may make 220 a decision of changing from a lighter energy saving mode to a deeper energy saving mode, for example, changing from a normal mode to a deep sleep mode. Accordingly, the network device 120 may transmit 230, to the terminal device 110, information (for convenience, also referred to as second information herein) of the change from a lighter energy saving mode to a deeper energy saving mode.

In some embodiments, the network device 120 may transmit the second information via system information. For example, using the system information update procedure to indicate the change of the energy saving mode. In some embodiments, the network device 120 may transmit the second information via a handover (HO) command from the cell 121. In some embodiments, the network device 120 may transmit the second information via a RRC release message. In some embodiments, the network device 120 may transmit the second information via a cell defined synchronization signal and physical broadcast channel block (CD-SSB) scheduling no system information block 1 (SIB1). In some embodiments, the network device 120 may transmit the second information along with the configuration for wake up of the cell 121.

In this way, a network may inform a terminal device of energy mode change. Then the network device 120 may switch 240 to the deeper energy saving mode.

It is to be noted that the order of the operation 210 and the operations 220 to 240 is not limited to that shown in FIG. 2. The operation 210 may be performed before the any of operations 220 to 240 or after any of the operations 220 to 240 or simultaneously with any of the operations 220 to 240. The present disclosure does not limit this aspect.

### Wake Up Decision

Continue to refer to FIG. 2, the terminal device 110 may determine 250 whether to transmit a wake up request to the network device 120 for wake up of the first cell (e.g., the cell 121). In some embodiments, the network device 130 and the network device 120 may be the same device. In some embodiments, the network device 130 and the network device 120 may be different devices. For example, the network device 130 may be a serving cell of the terminal device 110 and the network device 120 may be a neighbour cell of the terminal device 110. As another example, the network device 130 may be a macro cell and the network device 120 may be a micro cell.

In some embodiments, the terminal device 110 may determine whether to transmit a wake up request based on a condition for transmission of a wake up request comprised in the first configuration.

In some embodiments where the network device 130 and the network device 120 may be different devices, if the terminal device 110 receives, from a cell (e.g., the cell 131) provided by the network device 130, an indication to transmit the wake up request, the terminal device 110 may determine to transmit the wake up request to the network device 120.

In some embodiments where the network device 130 and the network device 120 may be different devices, if the terminal device 110 determines that quality of the cell 131 is below (e.g., lower than or equal to) threshold quality, the terminal device 110 may determine to transmit the wake up request to the network device 120.

In some embodiments, if there is no suitable cell to camp on, the terminal device 110 may determine to transmit the wake up request to the network device 120.

### Wake Up Request

Continue to refer to FIG. 2, the terminal device 110 may transmit 260 a wake up request to the network device 120 based on the configuration for wake up of the first cell (e.g., the cell 121) provided by the network device 120. It is to be understood that the terminal device 110 may transmit the wake up request at any time without any condition limitation. That is, the above determination 250 may be optional.

In some embodiments where occasions in a time window are associated with SSBs, the terminal device 110 may select at least one SSB from the SSBs. In some embodiments, the terminal device 110 may select the at least one of the SSBs that has reference signal receiving power (RSRP) higher than or equal to threshold power. In some embodiments, the terminal device 110 may select any of the SSBs if no SSB have RSRP higher than or equal to the threshold power. In some embodiments, the terminal device 110 may terminate transmission of the wake up request if no SSB have RSRP higher than or equal to the threshold power.

Upon selection of the at least one SSB, the terminal device 110 may determine an occasion from at least one occasion in the time window corresponding to the at least one SSB. Then the terminal device 110 may transmit the wake up request on the determined occasion. For example, as shown in FIGS. 4A to 4C, if the terminal device 110 determines that an SSB received via the beam 2 has the highest RSRP, the terminal device 110 may transmit the wake up request on the occasion RO2.

For example, an example procedure may be described as below.

```
  If at least one of the SSBs with SS-RSRP above rsrp-ThresholdSSB is
available:
    Select the SSB with SS-RSRP above rsrp-ThresholdSSB
  Else
    Select any SSB (or terminate the request);
  If at least one of the SSBs is selected, determine the next available request
occasion from the candidate request occasions in the next available time
window corresponding to the selected SSB;
Transmit the wake up request at the determined request occasion.
```

As another example, an example procedure may be described as below.

```
  If at least one of the SSBs with SS-RSRP above rsrp-ThresholdSSB is
available:
    Select N SSB with SS-RSRP above rsrp-ThresholdSSB (N can base
on repetition number)
  Else
    Select any SSB (or terminate the request);
  If at least one of the SSBs is selected, determine all available request
occasions from the candidate request occasions in the next available request
window corresponding to the selected SSBs;
Transmit the wake up request at the determined request occasions.
```

In this way, a terminal device may select and transmit a wake up request on best beams. According to the time or frequency domain resource position where receiving the wake up request, NW may know the best DL beam for the terminal device. And NW may decide to only wake up part of beams.

### Exception Handling

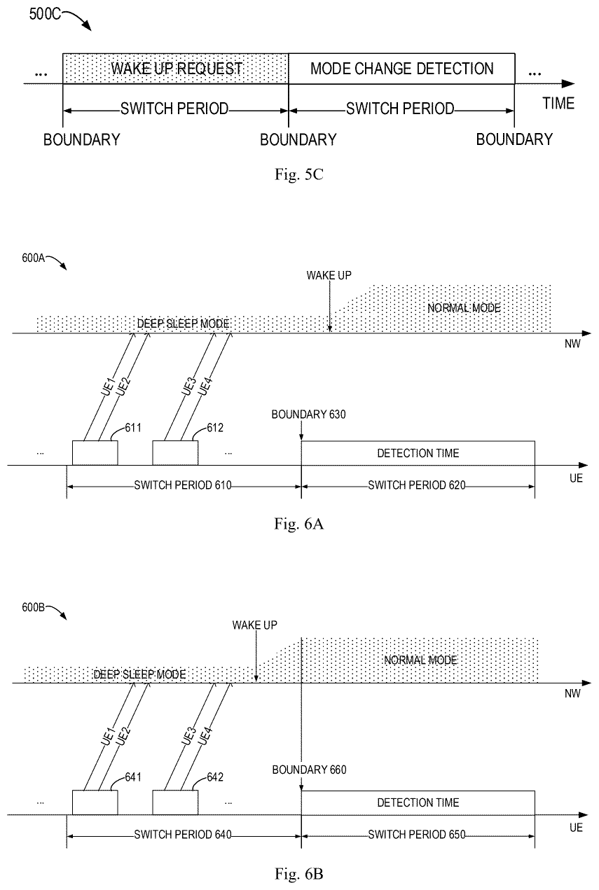

In some embodiments where switch periods are alternatively used for wake up request transmission and mode change detection, terminal devices which transmit wake up requests in the same switch period will detect the mode change of the NW from the same time boundary or during the same time period. The mode change of the NW may be completed at any time during the following switch period. FIG. 6A illustrates a schematic diagram 600A illustrating an example scenario of mode change of a cell according to embodiments of the present disclosure. In this example, two switch periods 610 and 620 are shown. UE1 and UE2 transmit wake up requests in the time window 611 within the switch period 610, and UE3 and UE4 transmit wake up requests in the time window 612 within the switch period 610. UE1, UE2, UE3 and UE4 may start detecting mode change of the NW at a boundary 630. As the mode change of the NW may occur after the boundary 630, UE1, UE2, UE3 and UE4 may detect the mode change of the NW.

In some scenarios, the NW may be expected to complete the mode change at a boundary between switch periods. FIG. 6B illustrates a schematic diagram 600B illustrating another example scenario of mode change of a cell according to embodiments of the present disclosure. In this example, two switch periods 640 and 650 are shown. UE1 and UE2 transmit wake up requests in the time window 641 within the switch period 640, and UE3 and UE4 transmit wake up requests in the time window 642 within the switch period 640. UE1, UE2, UE3 and UE4 may start detecting mode change of the NW at a boundary 660. The mode change of the NW may complete at least at the boundary 660.

In this case, if a terminal device transmits a wake up request at a time window close to the boundary 660, although the wake up request may be received by the NW, the wake up request may too late to be taken into consideration, or NW may not have enough time to ramp up and complete the mode change right before the boundary 660.

In view of this, embodiments of the present disclosure provide a solution to solve the above issue. In some embodiments, the terminal device 110 may transmit the wake up request during a time window in a switch period, an index of the time window being lower than a predetermined index. For example, the terminal device 110 may only transmit a wake up request during the first period of time T in a switch period. As another example, the terminal device 110 may only transmit a wake up request during first N time windows within a switch period. In other words, if a time window is very close the boundary; the time window may be considered as being invalid.

In some embodiments, the terminal device 110 may transmit the wake up request in response to remaining time before a boundary of a switch period being not less than threshold time. In other words, if the remaining time before upcoming boundary is less than threshold time, the terminal device 110 may terminate transmitting of the wake up request. In this case, the transmitting of the wake up request may be postponed to the next switch period. At the upcoming boundary, the terminal device 110 may first detect whether the mode change has been done as the NW may be woken up by other terminal device' requests.

### 3. Detection of Cell Mode Change

### Detection Time

Continue to refer to FIG. 2, after transmitting the wake up request, the terminal device 110 may detect 270 a change of an operation mode of the cell 121.

In some embodiments, the terminal device 110 may determine switch periods based on the second configuration (i.e., the detection configuration). The terminal device 110 may determine, from the switch periods, a switch period (for convenience, also referred to as a first switch period herein) in which the wake up request is transmitted. Then the terminal device 110 may detect the change of the operation mode of the cell 121 in a switch period (for convenience, also referred to as a second switch period herein) following the first switch period.

In some embodiments, the terminal device 110 may determine the switch periods by determining boundaries among the switch periods. In some embodiments, the terminal device 110 may determine the boundaries based on a configured number of system frames and a system frame number (SFN). For example, the terminal device 110 may determine SFN values associated with the boundaries based on equation (2) below.

$$SFN mod m = 0 \qquad ( 2 )$$

where m is the configured number of system frames. In this case, the boundaries are determined to be located at the start of an SFN meeting the condition described in the equation (2).

In some embodiments, the terminal device 110 may determine boundaries among the switch periods based on a configured number of system frames, a hyper system frame number (H-SFN) and SFN. For example, the terminal device 110 may determine SFN values associated with the boundaries based on equation (3) below. In this case, m may be larger than 1024 system frames.

$$( H - SFN * 1024 + SFN ) mod m = 0 \qquad ( 3 )$$

where m is the configured number of system frames. In this case, the boundaries are determined to be located at the start of an SFN meeting the condition described in the equation (3).

In some embodiments, the terminal device 110 may determine boundaries among the switch periods based on a configured number of system frames and an H-SFN. For example, the terminal device 110 may determine H-SFN values associated with the boundaries based on equation (4) below.

$$H - SFN mod m = 0 \qquad ( 4 )$$

where m is the configured number of hyper system frames. In this case, the boundaries are determined to be located at the start of an H-SFN meeting the condition described in the equation (4).

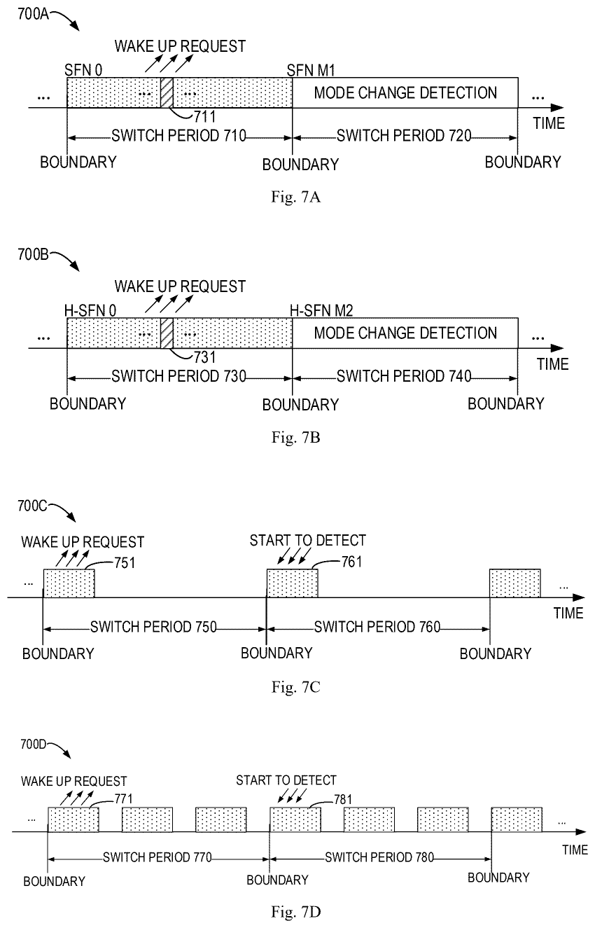

FIG. 7A illustrates a schematic diagram 700A illustrating an example determination of a boundary of a switch period according to embodiments of the present disclosure. As shown in FIG. 7A, a start of SFN 0, M1 (M1 mod m=0) may be determined as boundaries of switch periods 710 and 720 based on the equation (2). In this case, a length of one switch period is m system frames. As a wake up request is transmitted in a time window 711 within the switch period 710, mode change detection is made in the switch period 720.

FIG. 7B illustrates a schematic diagram 700B illustrating another example determination of a boundary of a switch period according to embodiments of the present disclosure. As shown in FIG. 7B, a start of H-SFN 0, M2 (M2 mod m=0) may be determined as boundaries of switch periods 730 and 740 based on the equation (4). In this case, a length of one switch period is m hyper system frames. As a wake up request is transmitted in a time window 731 within the switch period 730, mode change detection is made in the switch period 740.

In some embodiments, the terminal device 110 may determine boundaries among the switch periods based on a start of a predetermined time window: The predetermined time window may be configured or predefined. For example, the predetermined time window may be the N^{th} time window in a switch period. FIG. 7C illustrates a schematic diagram 700C illustrating another example determination of a boundary of a switch period according to embodiments of the present disclosure. It is assumed that after transmitting the wake up request, the start of next time window is configured as a boundary for mode change detection, thus the switch period 750 and switch period 751 are determined. In this case, a length of one switch period is the period of time window: As shown in FIG. 7C, if a wake up request is transmitted in the time window 751 of the switch period 750, mode change detection is started from the time window 761 of the switch period 760.

In some embodiments, after transmitting the wake up request, the terminal device 110 may try to detect the mode change from the start of the next time window whose index is an integer multiple of N. FIG. 7D illustrates a schematic diagram 700D illustrating another example determination of a boundary of a switch period according to embodiments of the present disclosure. It is assumed that the start of next time window whose index is an integer multiple of 3 is configured as a boundary for mode change detection. As shown in FIG. 7D, if a wake up request is transmitted in a time window 771 (in this example, corresponding to the first time window and the index of the time window 771 is 0), mode change detection is started from the 4^{th} time window 781 (the index of the time window 781 is 3, which is an integer multiple of 3).

In some embodiments, the terminal device 110 may determine a boundary based on a timer. For example, the timer may be started upon transmission of a wake up request and mode change detection may be made at expiration of the timer.

It is to be understood that any other suitable ways are also feasible for the determination of the switch periods or boundaries among the switch periods.

### Detection of Successful Wake Up

In some embodiments, if the terminal device 110 receives an SSB from the cell 121, the terminal device 110 may determine that wake up of the cell 121 is successful. In some embodiments, if the terminal device 110 detects regular SSB transmission, the terminal device 110 may determine that wake up of the cell 121 is successful.

In some embodiments, if the cell 121 is available for access, the terminal device 110 may determine that wake up of the cell 121 is successful. For example, the cell 121 is not considered as barred for terminal device 110.

In some embodiments, if system information from the cell 121 indicates the change of an operation mode of the cell 121 from the first mode (i.e., the deeper energy saving mode) to the second mode (i.e., the lighter energy saving mode), the terminal device 110 may determine that wake up of the cell 121 is successful. For example, if no SIB1 scheduled on CD-SSB as a sleep mode, the terminal device 110 may determine that wake up of the cell 121 is successful. As another example, if SIB1 scheduled on CD-SSB as a wake up mode, the terminal device 110 may determine that wake up of the cell 121 is successful.

It is to be understood that any combination of the above conditions and any other suitable conditions are also feasible for determination of a successful wake up request.

### Detection of Unsuccessful Wake Up

In some embodiments, if the terminal device 110 does not receive any SSBs from the cell 121, the terminal device 110 may determine that wake up of the cell 121 is unsuccessful.

In some embodiments, if the cell 121 is still unavailable for access, the terminal device 110 may determine that wake up of the cell 121 is unsuccessful. For example, the cell 121 is considered as barred for terminal device 110.

In some embodiments, if system information from the cell 121 indicates an operation of the cell 121 in the first mode (i.e., the deeper energy saving mode), the terminal device 110 may determine that wake up of the cell 121 is unsuccessful.

It is to be understood that any combination of the above conditions and any other suitable conditions are also feasible for determination of an unsuccessful wake up request.

### Re-Initiating of Wake Up Request

In some embodiments, if wake up of the cell 121 is unsuccessful, the terminal device 110 may re-initiate the wake up request after at least a predetermined period of time.

In some embodiments, the predetermined period of time may be a configured or predefined time length. In some embodiments, the predetermined period of time may be a predetermined number of time windows. In some embodiments, the predetermined period of time may be a predetermined number of switch periods. It is to be understood that the predetermined period of time may be determined in any other suitable ways.

### 4. Storage of Wake Up Request Information

Continue to refer to FIG. 2, the terminal device 110 may store 280 information of unsuccessful or successful wake up request.

In some embodiments, the information of unsuccessful or successful wake up request may comprise time stamp of transmitting the wake up request.

In some embodiments, the information of unsuccessful or successful wake up request may comprise the number of attempts of the wake up request.

In some embodiments, the information of unsuccessful or successful wake up request may comprise a cause of the wake up request. For example, the cause may comprise at least one of the following: last serving cell deterioration; last serving cell indicated; load balance; no suitable cell or any cell selection.

In some embodiments, the information of unsuccessful or successful wake up request may comprise latency time of the wake up. For example, time from the first wake up attempt to successfully access, or time from the first wake up attempt to available for access.

It is to be understood that the information of unsuccessful or successful wake up request may comprise any combination of the above information and any other suitable information.

### 5. Report of Wake Up Request Information

Continue to refer to FIG. 2, the terminal device 110 may transmit 290 availability of the information of unsuccessful or successful wake up request.

The network device 130 may transmit 291, to the terminal device 110, a request for obtaining the information of unsuccessful or successful wake up request.

The terminal device 110 may transmit 292 the information of unsuccessful or successful wake up request to the network device 120.

In this way, the wake up information may be logged and reported for use in self organized network (SON)/minimization of drive tests (MDT) optimization.

### Example Implementation of Methods

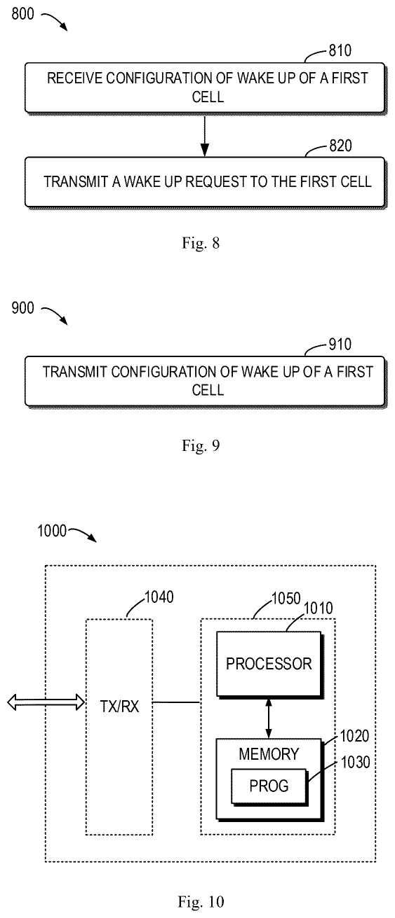

Accordingly, embodiments of the present disclosure provide methods of communication implemented at a terminal device and an access network device. These methods will be described below with reference to FIGS. 8 to 9.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 receives a configuration for wake up of a first cell (e.g., the cell 121). In some embodiments, the configuration may comprise at least one of the following: a first configuration for transmission of the wake up request: or a second configuration for detection of a change of an operation mode of the first cell from a first mode to a second mode, the first mode having deeper energy saving than the second mode.

In some embodiments, the first configuration may comprise at least one of the following: information of a time window for transmission of the wake up request; a condition for transmission of the wake up request; a maximum number of wake up request attempts; maximum number of repetitions for a wake up request attempt; earliest time of transmission of the wake up request; an indication of synchronization between network devices; or an indication indicating whether a system frame number and a frame boundary is aligned between a serving cell and a neighboring cell.

In some embodiments, the information of the time window may comprise information for determining a starting position of the time window and a duration of the time window. In some embodiments, the information for determining the starting position may comprise at least one of the following: periodicity of the time window; an offset of a system frame of the time window; a starting subframe of the time window; an offset to a SSB transmission; an offset to a SMTC window; or an offset to a predefined signal. In some embodiments, the offset to an SSB transmission may comprise: a time offset to time domain positions of SSBs; a time offset to a half frame with SSBs; or a time offset to a subframe or slot in which an SSB starts. In some embodiments, the time window may comprise occasions associated with SSBs.

In some embodiments, the maximum number of wake up request attempts may comprise at least one of the following: maximum times of wake up request attempts; or maximum times of wake up request attempts in a period of time.

In some embodiments, the condition for transmission of the wake up request may comprise at least one of the following: an indication to transmit the wake up request being received from a third cell; quality of a fourth cell being below threshold quality; or no cell to camp on.

In some embodiments, the second configuration may comprise at least one of the following: earliest time for detecting the change of the operation mode of the first cell; latest time for detecting the change of the operation mode of the first cell; or the number of system frames for determining switch periods.

In some embodiments, the terminal device 110 may receive, from the first cell, the configuration for wake up of the first cell. In some embodiments, the terminal device 110 may receive, from a second cell, the configuration for wake up of the first cell.

At block 820, the terminal device 110 transmits a wake up request to the first cell based on the configuration.

In some embodiments where the time window comprises occasions associated with SSBs, the terminal device 110 may select at least one SSB from the SSBs; determine an occasion from at least one occasion in the time window corresponding to the at least one SSB; and transmit the wake up request on the determined occasion. In some embodiments, the terminal device 110 may select the at least one of the SSBs that has RSRP higher than or equal to threshold power. In some embodiments, the terminal device 110 may select any of the SSBs. In some embodiments, the terminal device 110 may terminate transmission of the wake up request if no SSB have RSRP higher than or equal to the threshold power.

In some embodiments, the terminal device 110 may transmit the wake up request during a time window in a switch period, an index of the time window being lower than a predetermined index. In some embodiments, the terminal device 110 may transmit the wake up request in response to remaining time before a boundary of a switch period being not less than threshold time.

In some embodiments, the terminal device 110 may further receive information of a change of an operation mode of the first cell from the second mode to the first mode via at least one of the following: system information; a handover command from the first cell; a RRC release message; or a CD-SSB scheduling no SIB1.

In some embodiments, the terminal device 110 may further detect, based on the second configuration, the change of the operation mode of the first cell from the first mode to the second mode. In some embodiments, the terminal device 110 may determine switch periods based on the second configuration; determine, from the switch periods, a first switch period in which the wake up request is transmitted; and detect the change of the operation mode of the first cell in a second switch period following the first switch period.

In some embodiments, the terminal device 110 may determine the switch periods by determining boundaries among the switch periods based on at least one of the following: the number of system frames and at least one of a system frame number or a hyper system frame number: or start of a predetermined time window.

In some embodiments, the terminal device 110 may detect the change the operation mode of the first cell by determining that wake up of the first cell is unsuccessful in response to at least one of the following: receiving no SSB from the first cell; the first cell being unavailable for access; or system information from the first cell indicating an operation of the first cell in the first mode; or determining that wake up of the first cell is successful in response to at least one of the following: an SSB from the first cell being detected; the first cell being available for access; or system information from the first cell indicating the change of the operation mode of the first cell.

In some embodiments, if wake up of the first cell is unsuccessful, the terminal device 110 may further re-initiate the wake up request after at least a predetermined period of time. In some embodiments, the predetermined period of time may comprise a predetermined number of time windows; or a predetermined number of switch periods.

In some embodiments, the terminal device 110 may further store information of unsuccessful or successful wake up request, the information of unsuccessful or successful wake up request comprising at least one of the following: time stamp of transmitting the wake up request; the number of attempts of the wake up request; a cause of the wake up request; or latency time of the wake up.

In some embodiments, the terminal device 110 may further transmit availability of the information of unsuccessful or successful wake up request; receive a request for obtaining the information of unsuccessful or successful wake up request; and transmit the information of unsuccessful or successful wake up request.

With the method 800, a terminal device may a terminal device may activate a network from a deeper energy saving mode to a lighter energy saving mode.

FIG. 9 illustrates an example method 900 of communication implemented at a network device in accordance with some embodiments of the present disclosure. For example, the method 900 may be performed at the network device 120 or 130 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the network device 130 transmits a configuration for wake up of a first cell (e.g., the cell 121 of the network device 120), the configuration comprising at least one of the following: a first configuration for transmission of a wake up request; or a second configuration for detection of a change of an operation mode of the first cell from a first mode to a second mode, the first mode having deeper energy saving than the second mode.

In some embodiments, the first cell may be provided by the network device 130 or a further network device.

In some embodiments, the first configuration may comprise at least one of the following: information of a time window for transmission of the wake up request; a condition for transmission of the wake up request; a maximum number of wake up request attempts; maximum number of repetitions for a wake up request attempt; earliest time of transmission of the wake up request; an indication of synchronization between network devices; or an indication indicating whether a system frame number and a frame boundary is aligned between a serving cell and a neighboring cell.

In some embodiments, the information of the time window may comprise information for determining a starting position of the time window and a duration of the time window. In some embodiments, the information for determining the starting position may comprise at least one of the following: periodicity of the time window; an offset of a system frame of the time window; a starting subframe of the time window; an offset to a SSB transmission; an offset to a SMTC window; or an offset to a predefined signal. In some embodiments, the offset to an SSB transmission may comprise: a time offset to time domain positions of SSBs; a time offset to a half frame with SSBs; or a time offset to a subframe or slot in which an SSB starts. In some embodiments, the time window may comprise occasions associated with SSBs.

In some embodiments, the maximum number of wake up request attempts may comprise at least one of the following: maximum times of wake up request attempts; or maximum times of wake up request attempts in a period of time.

In some embodiments, the condition for transmission of the wake up request may comprise at least one of the following: an indication to transmit the wake up request being received from a third cell; quality of a fourth cell being below threshold quality; or no cell to camp on.

In some embodiments, the second configuration may comprise at least one of the following: earliest time for detecting the change of the operation mode of the first cell; latest time for detecting the change of the operation mode of the first cell; or the number of system frames for determining switch periods.

In some embodiments, the network device 130 may further transmit information of a change of an operation mode of the first cell from the second mode to the first mode via at least one of the following: system information; a handover command from the first cell; a radio resource control release message; or a CD-SSB scheduling no system information block 1.

In some embodiments, the network device 130 may further receive the wake up request.

In some embodiments, the network device 130 may further receive availability of information of unsuccessful or successful wake up request; transmit a request for obtaining the information of unsuccessful or successful wake up request; and receive the information of unsuccessful or successful wake up request.

In some embodiments, the information of unsuccessful or successful wake up request may comprise at least one of the following: time stamp of transmitting the wake up request; the number of attempts of the wake up request; a cause of the wake up request; or latency time of the wake up.

With the method 900, a network may be activated from a deeper energy saving mode to a lighter energy saving mode.

### Example Implementation of Device and Apparatus

FIG. 10 is a simplified block diagram of a device 1000 that is suitable for implementing embodiments of the present disclosure. The device 1000 can be considered as a further example implementation of the terminal device 110 or the network device 120 or 130 as shown in FIG. 1. Accordingly, the device 1000 can be implemented at or as at least a part of the terminal device 110 or the network device 120 or 130.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises a circuitry configured to: receive a configuration for wake up of a first cell; and transmit a wake up request to the first cell based on the configuration, the configuration comprising at least one of the following: a first configuration for transmission of the wake up request; or a second configuration for detection of a change of an operation mode of the first cell from a first mode to a second mode, the first mode having deeper energy saving than the second mode.

In some embodiments, a network device comprises a circuitry configured to: transmit a configuration for wake up of a first cell, the configuration comprising at least one of the following: a first configuration for transmission of a wake up request; or a second configuration for detection of a change of an operation mode of the first cell from a first mode to a second mode, the first mode having deeper energy saving than the second mode.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receiving, at a terminal device, a configuration for wake up of a first cell; and transmitting a wake up request to the first cell based on the configuration, the configuration comprising at least one of the following: a first configuration for transmission of the wake up request; or a second configuration for detection of a change of an operation mode of the first cell from a first mode to a second mode, the first mode having deeper energy saving than the second mode.

In some embodiments, the method described above further comprises: receiving information of a change of an operation mode of the first cell from the second mode to the first mode via at least one of the following: system information; a handover command from the first cell; a radio resource control release message; or a cell defined synchronization signal and physical broadcast channel block (CD-SSB) scheduling no system information block 1.

In some embodiments, receiving the configuration for wake up of the first cell comprises: receiving, from the first cell, the configuration for wake up of the first cell; or receiving, from a second cell, the configuration for wake up of the first cell.

In some embodiments, the first configuration comprises at least one of the following: information of a time window for transmission of the wake up request; a condition for transmission of the wake up request: a maximum number of wake up request attempts; maximum number of repetitions for a wake up request attempt; earliest time of transmission of the wake up request; an indication of synchronization between network devices; or an indication indicating whether a system frame number and a frame boundary is aligned between a serving cell and a neighboring cell.

In some embodiments, the information of the time window comprises information for determining a starting position of the time window and a duration of the time window, and wherein the information for determining the starting position comprises at least one of the following: periodicity of the time window: an offset of a system frame of the time window; a starting subframe of the time window; an offset to a synchronization signal and physical broadcast channel block (SSB) transmission; an offset to an SSB measurement timing configuration (SMTC) window; or an offset to a predefined signal.

In some embodiments, the offset to an SSB transmission comprises: a time offset to time domain positions of SSBs; a time offset to a half frame with SSBs; or a time offset to a subframe or slot in which an SSB starts.

In some embodiments, the maximum number of wake up request attempts comprises at least one of the following: maximum times of wake up request attempts; or maximum times of wake up request attempts in a period of time.

In some embodiments, the condition for transmission of the wake up request comprises at least one of the following: an indication to transmit the wake up request being received from a third cell; quality of a fourth cell being below threshold quality; or no cell to camp on.

In some embodiments, the time window comprises occasions associated with synchronization signal and physical broadcast channel blocks (SSBs), and wherein transmitting the wake up request comprises: selecting at least one SSB from the SSBs; determining an occasion from at least one occasion in the time window corresponding to the at least one SSB; and transmitting the wake up request on the determined occasion.

In some embodiments, selecting the at least one SSB comprises: selecting the at least one of the SSBs that has reference signal receiving power (RSRP) higher than or equal to threshold power; or selecting any of the SSBs or terminating transmission of the wake up request if no SSB have RSRP higher than or equal to the threshold power.

In some embodiments, the second configuration comprises at least one of the following: earliest time for detecting the change of the operation mode of the first cell; latest time for detecting the change of the operation mode of the first cell; or the number of system frames for determining switch periods.

In some embodiments, the method described above further comprises: detecting, based on the second configuration, the change of the operation mode of the first cell from the first mode to the second mode.

In some embodiments, detecting the change of the operation mode of the first cell comprises: determining switch periods based on the second configuration; determining, from the switch periods, a first switch period in which the wake up request is transmitted; and detecting the change of the operation mode of the first cell in a second switch period following the first switch period.

In some embodiments, determining the switch periods comprises: determining boundaries among the switch periods based on at least one of the following; the number of system frames and at least one of a system frame number or a hyper system frame number; or start of a predetermined time window.

In some embodiments, detecting the change the operation mode of the first cell comprises: determining that wake up of the first cell is unsuccessful in response to at least one of the following: receiving no SSB from the first cell; the first cell being unavailable for access; or system information from the first cell indicating an operation of the first cell in the first mode; or determining that wake up of the first cell is successful in response to at least one of the following: an SSB from the first cell being detected; the first cell being available for access; or system information from the first cell indicating the change of the operation mode of the first cell.

In some embodiments, the method described above further comprises: in accordance with a determination that wake up of the first cell is unsuccessful, re-initiating the wake up request after at least a predetermined period of time.

In some embodiments, the predetermined period of time comprises: a predetermined number of time windows; or a predetermined number of switch periods.

In some embodiments, transmitting the wake up request comprises: transmitting the wake up request during a time window in a switch period, an index of the time window being lower than a predetermined index; or transmitting the wake up request in response to remaining time before a boundary of a switch period being not less than threshold time.

In some embodiments, the method described above further comprises: storing information of unsuccessful or successful wake up request, the information of unsuccessful or successful wake up request comprising at least one of the following: time stamp of transmitting the wake up request; the number of attempts of the wake up request; a cause of the wake up request; or latency time of the wake up.

In some embodiments, the method described above further comprises: transmitting availability of the information of unsuccessful or successful wake up request; receiving a request for obtaining the information of unsuccessful or successful wake up request; and transmitting the information of unsuccessful or successful wake up request.

In another solution, a method of communication comprises: transmitting, at a network device, a configuration for wake up of a first cell, the configuration comprising at least one of the following: a first configuration for transmission of a wake up request; or a second configuration for detection of a change of an operation mode of the first cell from a first mode to a second mode, the first mode having deeper energy saving than the second mode.

In some embodiments, the method described above further comprises: transmitting information of a change of an operation mode of the first cell from the second mode to the first mode via at least one of the following: system information; a handover command from the first cell; a radio resource control release message; or a cell defined synchronization signal and physical broadcast channel block (CD-SSB) scheduling no system information block 1.

In some embodiments, the first cell is provided by the network device or a further network device.

In some embodiments, the first configuration comprises at least one of the following: information of a time window for transmission of the wake up request; a condition for transmission of the wake up request; a maximum number of wake up request attempts; maximum number of repetitions for a wake up request attempt; earliest time of transmission of the wake up request; an indication of synchronization between network devices; or an indication indicating whether a system frame number and a frame boundary is aligned between a serving cell and a neighboring cell.

In some embodiments, the information of the time window comprises information for determining a starting position of the time window and a duration of the time window, and wherein the information for determining the starting position comprises at least one of the following: periodicity of the time window; an offset of a system frame of the time window; a starting subframe of the time window; an offset to a synchronization signal and physical broadcast channel block (SSB) transmission; an offset to an SSB measurement timing configuration (SMTC) window; or an offset to a predefined signal.

In some embodiments, the offset to an SSB transmission comprises: a time offset to time domain positions of SSBs; a time offset to a half frame with SSBs; or a time offset to a subframe or slot in which an SSB starts.

In some embodiments, the maximum number of wake up request attempts comprises at least one of the following: maximum times of wake up request attempts; or maximum times of wake up request attempts in a period of time.

In some embodiments, the condition for transmission of the wake up request comprises at least one of the following: an indication to transmit the wake up request being received from a third cell; quality of a fourth cell being below threshold quality; or no cell to camp on.

In some embodiments, the time window comprises occasions associated with synchronization signal and physical broadcast channel blocks (SSBs).

In some embodiments, the second configuration comprises at least one of the following: earliest time for detecting the change of the operation mode of the first cell; latest time for detecting the change of the operation mode of the first cell; or the number of system frames for determining switch periods.

In some embodiments, the method described above further comprises: receiving the wake up request.

In some embodiments, the method described above further comprises: receiving availability of information of unsuccessful or successful wake up request; transmitting a request for obtaining the information of unsuccessful or successful wake up request; and receiving the information of unsuccessful or successful wake up request.

In some embodiments, the information of unsuccessful or successful wake up request comprises at least one of the following: time stamp of transmitting the wake up request; the number of attempts of the wake up request; a cause of the wake up request; or latency time of the wake up.

In another solution, a device of communication comprises: a processor configured to perform the method according to any of the methods described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
receiving, at a terminal device, a configuration for wake up of a first cell; and
transmitting a wake up request to the first cell based on the configuration, the configuration comprising at least one of the following:
a first configuration for transmission of the wake up request; or a second configuration for detection of a change of an operation mode of the first
cell from a first mode to a second mode, the first mode having deeper energy saving than the second mode.

2. The method of claim 1, further comprising:
receiving information of a change of an operation mode of the first cell from the second mode to the first mode via at least one of the following:
system information;
a handover command from the first cell;
a radio resource control release message; or
a cell defined synchronization signal and physical broadcast channel block (CD-SSB) scheduling no system information block 1.

3. The method of claim 1, wherein receiving the configuration for wake up of the first cell comprises:
receiving, from the first cell, the configuration for wake up of the first cell; or
receiving, from a second cell, the configuration for wake up of the first cell.

4. The method of claim 1, wherein the first configuration comprises at least one of the following:
information of a time window for transmission of the wake up request;
a condition for transmission of the wake up request;
a maximum number of wake up request attempts;
maximum number of repetitions for a wake up request attempt;
earliest time of transmission of the wake up request;
an indication of synchronization between network devices; or
an indication indicating whether a system frame number and a frame boundary is aligned between a serving cell and a neighboring cell.

5. The method of claim 4, wherein the information of the time window comprises information for determining a starting position of the time window and a duration of the time window, and wherein the information for determining the starting position comprises at least one of the following:
periodicity of the time window;
an offset of a system frame of the time window;
a starting subframe of the time window;
an offset to a synchronization signal and physical broadcast channel block (SSB) transmission;
an offset to an SSB measurement timing configuration (SMTC) window; or
an offset to a predefined signal.

6. The method of claim 5, wherein the offset to an SSB transmission comprises:
a time offset to time domain positions of SSBs;
a time offset to a half frame with SSBs; or
a time offset to a subframe or slot in which an SSB starts.

7. The method of claim 4, wherein the maximum number of wake up request attempts comprises at least one of the following:
maximum times of wake up request attempts; or
maximum times of wake up request attempts in a period of time.

8. The method of claim 4, wherein the condition for transmission of the wake up request comprises at least one of the following:
an indication to transmit the wake up request being received from a third cell;
quality of a fourth cell being below threshold quality; or
no cell to camp on.

9. The method of claim 4, wherein the time window comprises occasions associated with synchronization signal and physical broadcast channel blocks (SSBs), and wherein transmitting the wake up request comprises:
selecting at least one SSB from the SSBs;
determining an occasion from at least one occasion in the time window corresponding to the at least one SSB; and
transmitting the wake up request on the determined occasion.

10. The method of claim 9, wherein selecting the at least one SSB comprises:
selecting the at least one of the SSBs that has reference signal receiving power (RSRP) higher than or equal to threshold power; or
selecting any of the SSBs or terminating transmission of the wake up request if no SSB have RSRP higher than or equal to the threshold power.

11. The method of claim 1, wherein the second configuration comprises at least one of the following:
earliest time for detecting the change of the operation mode of the first cell;
latest time for detecting the change of the operation mode of the first cell; or
the number of system frames for determining switch periods.

12. The method of claim 1, further comprising:
detecting, based on the second configuration, the change of the operation mode of the first cell from the first mode to the second mode.

13. The method of claim 12, wherein detecting the change of the operation mode of the first cell comprises:
determining switch periods based on the second configuration;
determining, from the switch periods, a first switch period in which the wake up request is transmitted; and
detecting the change of the operation mode of the first cell in a second switch period following the first switch period.

14. The method of claim 13, wherein determining the switch periods comprises:
determining boundaries among the switch periods based on at least one of the following:
the number of system frames and at least one of a system frame number or a hyper system frame number; or
start of a predetermined time window.

15. The method of claim 12, wherein detecting the change the operation mode of the first cell comprises:
determining that wake up of the first cell is unsuccessful in response to at least one of the following:
receiving no SSB from the first cell;
the first cell being unavailable for access; or
system information from the first cell indicating an operation of the first cell in the first mode; or
determining that wake up of the first cell is successful in response to at least one of the following:
an SSB from the first cell being detected;
the first cell being available for access; or
system information from the first cell indicating the change of the operation mode of the first cell.

16. The method of claim 12, further comprising:
in accordance with a determination that wake up of the first cell is unsuccessful, re-initiating the wake up request after at least a predetermined period of time.

17. The method of claim 16, wherein the predetermined period of time comprises:
a predetermined number of time windows; or
a predetermined number of switch periods.

18. The method of claim 1, wherein transmitting the wake up request comprises:
transmitting the wake up request during a time window in a switch period, an index of the time window being lower than a predetermined index; or
transmitting the wake up request in response to remaining time before a boundary of a switch period being not less than threshold time.

19. The method of claim 1, further comprising:
storing information of unsuccessful or successful wake up request, the information of unsuccessful or successful wake up request comprising at least one of the following:
time stamp of transmitting the wake up request;
the number of attempts of the wake up request;
a cause of the wake up request; or
latency time of the wake up.

20. A device of communication comprising:
a processor configured to perform the method according to claim 1.
